(19) United States
(12) Patent Application Publication
(10) Pub. No.: US 2014/0214471 A1
(43) Pub. Date: Jul. 31, 2014

(54) System for Tracking Preparation Time and Attendance at a Meeting

(71) Applicant: Donald Raymond Schreiner, III, Sanford, FL (US)

(72) Inventor: Donald Raymond Schreiner, III, Sanford, FL (US)

(21) Appl. No.: 13/755,053

(22) Filed: Jan. 31, 2013

(51) Int. Cl. G06Q 10/10

(52) U.S. Cl. CPC G06Q 10/1095
USPC 705/7.19

(57) ABSTRACT

Disclosed is a device for tracking preparation time and attendance at a meeting to occur at a meeting time and a meeting location for a meeting duration. The device includes a location determiner configured to determine a device location; a clock configured to determine a current time; an audio capability, the audio capability being disabled when the current time is near the meeting time; a unique identifier which is transmitted from the device indicating attendance at the meeting; a database configured to store a preparation time, the meeting time, meeting location, and meeting duration, and a meeting preparation materials; and a screen configured to display the preparation time, the meeting time, meeting location, and meeting duration, and the meeting preparation materials.

### BACKGROUND OF THE INVENTION

1. Field of the Invention

The embodiments of the invention relate to a time entry device, and more particularly, to a system for tracking preparation time and attendance at a meeting or series of meetings. Although embodiments of the invention are suitable for a wide scope of applications, it is particularly suitable for recording and reporting time spent preparing for a meeting, distributing meeting preparation materials, and reporting attendance at a meeting.

2. Discussion of the Related Art

In general, persons with a common interest congregate in meetings to provide information to one another or to just disseminate information. These meetings can be recreational or professional and can include meetings such as business meetings, club meetings, rallies, religious services, academic classes, gym classes, meetings with personal trainers, and the like. Generally speaking, a meeting may require some degree of preparation by the participants, such as the review of materials related to the subject matter of the meeting.

Meeting preparation materials are typically distributed in advance of the meeting by traditional methods, such as electronic mail, a website, postal mail, or hand delivery. In the instance of an academic meeting, such as a class, preparation materials for the next class are typically distributed or assigned verbally in the prior class. In the example of a math class, the preparation materials can include a reading assignment and practice problems. In the example of a religious service, the preparation materials can include a reading assignment in a holy book.

It is often advantageous for the participants at meetings as well as the meeting organizer to track or log the time spent preparing for the meeting as a measure of performance or preparedness for the meeting. In the related art, these preparation times were recorded on time sheets that could be reported to the meeting organizer for analysis.

Meetings may require attendance by the participants either in person or through some other communication media, such as telephonically. Further, a meeting organizers may desire to know which participants have attended the meeting. In the related art, attendance at a meeting was determined by roll-call or a sign-in sheet. The meeting organizer could use attendance data to determine the appeal of information disseminated at meetings.

Distribution of meeting preparation materials can be problemsome since distribution for subsequent meetings commonly occurs at a previous meeting. Participants in a series of meetings who miss one meeting are often unprepared for the subsequent meeting. Obtaining the meeting preparation materials often involves coordinating with other participants, requesting a special delivery from the meeting organizer, or using some other communication mechanism, such as a website.

Meeting preparation time is difficult to track and analyze because such data is recorded on paper media or may not be recorded at all. Even when preparation time data is recorded electronically, there is no standardized system for importing and analyzing preparation time data gathered from the meeting participants. Collection methods for meeting attendance data, such as roll-call, do not scale well to large groups, such as religious services and academic classes. Meeting organizers generally cannot access attendance data until after the meeting. Meeting participants typically bring electronic devices to meetings, such as cell phones or tablets, which can inadvertently create noise and disrupt a meeting with a ringer or preprogrammed alarm.

### SUMMARY OF THE INVENTION

Accordingly, embodiments of the invention are directed to a system for tracking preparation time and attendance at a meeting that substantially obviates one or more of the problems due to limitations and disadvantages of the related art.

An object of embodiments of the invention is to provide a user device for a meeting participant to record meeting preparation time.

Another object of embodiments of the invention is to provide a user device for sending meeting preparation time to a server or a meeting organizer.

Another object of embodiments of the invention is to provide a selectable audio capability for the user device to disable the audio capability of the user device during the meeting.

Another object of embodiments of the invention is to provide a user device which receives meeting preparation materials for a meeting.

Another object of the invention is to provide a data server for storing meeting preparation time of meeting participants, attendance data, and meeting preparation materials.

Yet another object of the invention is to provide an administrator device for specifying meeting preparation materials, reviewing meeting preparation time data, and reviewing attendance data.

Additional features and advantages of embodiments of the invention will be set forth in the description which follows, and in part will be apparent from the description, or may be learned by practice of embodiments of the invention. The objectives and other advantages of the embodiments of the invention will be realized and attained by the structure particularly pointed out in the written description and claims hereof as well as the appended drawings.

To achieve these and other advantages and in accordance with the purpose of embodiments of the invention, as embodied and broadly described, the system for tracking preparation time and attendance at a meeting includes a device for tracking preparation time and attendance at a meeting to occur at a meeting time and a meeting location for a meeting duration, comprising a location determiner configured to determine a device location; a clock configured to determine a current time; an audio capability, the audio capability being disabled when the current time is near the meeting time; a unique identifier which is transmitted from the device indicating attendance at the meeting; a database configured to store a preparation time, the meeting time, meeting location, and meeting duration, and a meeting preparation materials; and a screen configured to display the preparation time, the meeting time, meeting location, and meeting duration, and the meeting preparation materials.

In another aspect, the system for tracking preparation time and attendance at a meeting includes a device for tracking preparation time and attendance for a plurality of attendees at a meeting to occur at a meeting time and a meeting location for a meeting duration, comprising a communications module having a receiver configured to receive a preparation time, an attendance data, and a unique identifier for each of the plurality of attendees; and a transmitter configured to send a meeting preparation materials. The device further includes an analytics module having a processor configured to determine a collective attendance rate for the plurality of attendees at the meeting; to determine a historical attendance rate for each of the plurality of attendees, respectively; to determine a collective preparation time for the plurality of attendees at the meeting; and to determine a historical preparation time for each of the plurality of attendees, respectively;

In yet another aspect, the system for tracking preparation time and attendance at a meeting includes a device for tracking preparation time and attendance for a plurality of attendees at a meeting to occur at a meeting time and a meeting location for a meeting duration comprising a communications module configured to receive a preparation time, an attendance data, and a unique identifier for each of the plurality of attendees and configured to send the meeting time and duration to each of the plurality of attendees; a first database configured to store a meeting time, a meeting duration, and the preparation time, attendance data, and unique identifier for each of the plurality of attendees; and a second database configured to store a plurality of related materials pertaining to a subject matter of the meeting.

In still another aspect, the system for tracking preparation time and attendance at a meeting includes a user device, a data server and an administrator device. The user device includes a location determiner configured to determine a device location; a clock configured to determine a current time; an audio capability, the audio capability being selectively disabled in response to a criteria; a unique identifier; a communications module configured to receive the meeting time, meeting location, meeting duration, a meeting preparation materials, and a related materials; and configured to send a preparation time data and an attendance data; a first database configured to store the meeting time, the meeting location, the meeting duration, the meeting preparation materials, the related materials, the preparation time data, and the attendance data; and a screen configured to display the preparation time data, the meeting time, the meeting location, the meeting duration, and the meeting preparation materials. The data server includes a communications module configured to receive a preparation time, an attendance data, and a unique identifier for each of the plurality of attendees and configured to send the meeting time and duration to each of the plurality of attendees; a second database configured to store a meeting time, a meeting location, and a meeting duration; and configured to store the preparation time data, the attendance data, and unique identifier for each of the plurality of attendees; a third database configured to store a plurality of related materials pertaining to a subject matter of the meeting. The administrator device includes a communications module having a receiver configured to receive a preparation time, an attendance data, and a unique identifier for each of the plurality of attendees; and a transmitter configured to send a meeting preparation materials. The administrator device includes an analytics module having a processor configured to determine a collective attendance rate for the plurality of attendees at the meeting; to determine a historical attendance rate for each of the plurality of attendees, respectively; to determine a collective preparation time for the plurality of attendees at the meeting; and to determine a historical preparation time for each of the plurality of attendees, respectively.

It is to be understood that both the foregoing general description and the following detailed description are exemplary and explanatory and are intended to provide further explanation of embodiments of the invention as claimed.

### BRIEF DESCRIPTION OF THE DRAWINGS

The accompanying drawings, which are included to provide a further understanding of embodiments of the invention and are incorporated in and constitute a part of this specification, illustrate embodiments of the invention and together with the description serve to explain the principles of embodiments of the invention.

FIG. 1 is block diagram of a system for tracking time and attendance at a meeting according to an exemplary embodiment of the invention;

FIG. 2 is block diagram of a system for tracking time and attendance at a meeting according to an exemplary embodiment of the invention;

FIG. 3 is a block diagram of a user device according to an exemplary embodiment of the invention;

FIG. 4 is drawing of a login feature for a user device according to an exemplary embodiment of the invention;

FIG. 5 is a drawing of a organization selection feature for user device according to an exemplary embodiment of the invention;

FIG. 6 is a drawing of a meeting display feature for a user device according to an exemplary embodiment of the invention.

FIG. 7 is a drawing of a meeting materials feature for a user device according to an exemplary embodiment of the invention;

FIG. 8 is a drawing of a preparation time entry feature for a user device according to an exemplary embodiment of the invention;

FIG. 9 is a drawing of a historical preparation time display feature for a user device according to an exemplary embodiment of the invention;

FIG. 10 is a drawing of a meeting attendance and preparation time display feature for an administrator device according to an exemplary embodiment of the invention;

FIG. 11 is a process flow chart for a selectable audio capability according to according to an exemplary embodiment of the invention;

FIG. 12 is a process flow chart for recording time and attendance data at a user device according to an exemplary embodiment of the invention; and

FIG. 13 is a process flow chart for reviewing time and attendance data at an administrator device according to an exemplary embodiment of the invention.

### DETAILED DESCRIPTION OF THE PREFERRED EMBODIMENTS

Reference will now be made in detail to the preferred embodiments of the invention, examples of which are illustrated in the accompanying drawings. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, the thicknesses of layers and regions are exaggerated for clarity. Like reference numerals in the drawings denote like elements.

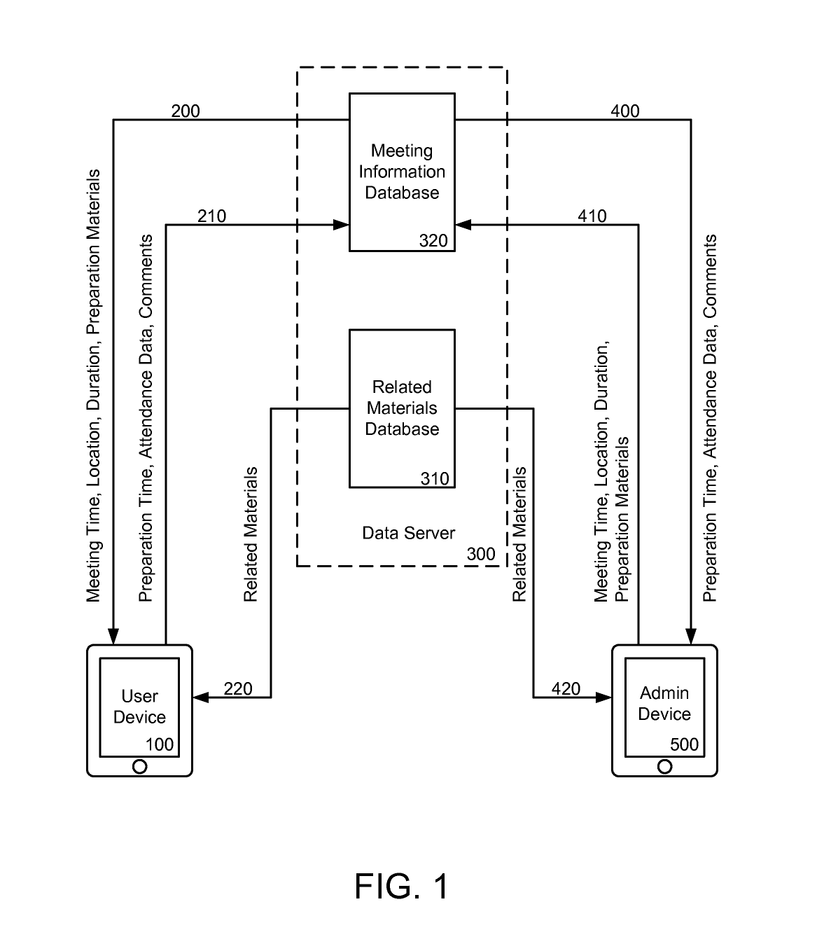

FIG. 1 is block diagram of a system for tracking time and attendance at a meeting according to an exemplary embodiment of the invention. As shown in FIG. 1, the system includes a user device 100, a data server 300, and an administrator device 500 (“admin device”). The data server 300 can include a related materials database 310 and a meeting information database 320. The admin device 500 can send meeting data 410 to the meeting information database 320 at the data server 300. The meeting data 410 can include the meeting time, meeting location, meeting duration, and preparation materials specific to the meeting. The meeting data 410 can include information for one meeting or many meetings in a series of meetings.

The user device 100 can receive meeting data 200 from the meeting information database 320 on the data server 300. Meeting data 200 can include the meeting time, meeting location, meeting duration, and preparation materials specific to the meeting. The meeting data 200 can include information for one meeting or many meetings in a series of meetings. Meeting preparation materials can include documents selected by a meeting organizer relating to the subject matter of the meeting. In the example of a religious meeting, the preparation materials can include discussion points for a religious service, lyrics or music for a song, and reading materials such as passages from holy books. In the example of a gym meeting, the preparation materials can include an exercise routine or diet plan. In the example of a business meeting, the preparation materials can include documents relating to the subject matter of the meeting such as power points, reports, or discussion points.

The user device 100 can receive related materials 220 from the related materials database 310 on the data server 300. The related materials 220 can be related to the subject matter of the meeting, but are not necessarily chosen by the meeting organizer and can be selected by the data server 300. In the example of a religious service, meeting preparation materials can be a passage in a religious text while related materials can include articles discussing the passage or other religious texts similar to the passage. In the example of a gym meeting, meeting preparation materials can include a diet plan or exercise routine while related materials might include other diet plans or other exercise routines.

The user device 100 can send participant data 210 to the meeting information database 320 on the data server 300. The participant data 210 can include time spent preparing for the meeting, meeting attendance data, and comments on the meeting preparation materials. Time spent preparing for the meeting can be recorded daily or hourly. In the example of a religious meeting, preparation time can be time spent reviewing the meeting preparation materials and praying. In the example of a gym meeting, the preparation time can be time spent doing independent exercise. Independent exercise can occur outside of the gym or without formal instruction or supervision. The attendance data can indicate when the user attends a scheduled meeting. In the example of a religious service, the attendance data can indicate the user attended a religious service. In the example of a gym meeting, the attendance data can indicate the user met with an athletic trainer or attending a class. The comments can include comments entered by the participant pertaining to the meeting preparation materials or related materials. The comments can indicate the participant's thoughts or impressions on the meeting preparation materials or related materials.

The admin device 500 can receive aggregated participant data 400 from the meeting information database 320 on the data server 300. The aggregated participant data 400 can include preparation time, attendance data, and comments for many meeting participants. The aggregated participant data 400 can include the number of participants present at a meeting or the number of participants absent from a meeting. The aggregated participant data 400 can include the comments of participants on the meeting preparation materials which can be reviewed by the meeting organizer. The comments can be additional discussion points at the meeting. The admin device 500 can also receive related materials 420 from the related materials database 310 on the data server 420. The related materials 420 can be the same as the related materials 220 available to the user device 100. The related materials 420 can include materials that related to the subject matter of the meeting, but are not necessarily selected by the meeting organizer.

The user device 100 and the admin device 500 can be general purpose computing devices, such as laptops computers or desktop computers. The user device 100 and the admin device 500 can be mobile devices, such as tablets, PDAs, or smart phones such as Android or Apple iOS devices. The communications between the user device 100, the data server 300, and the admin device 500 can be via private network, virtual private network, or the internet. The communication medium can be wireless such as through a mobile telephone network or WiFi. The communication medium can be wired such as with a modem over a telephone line or an Ethernet connection via a LAN or WAN.

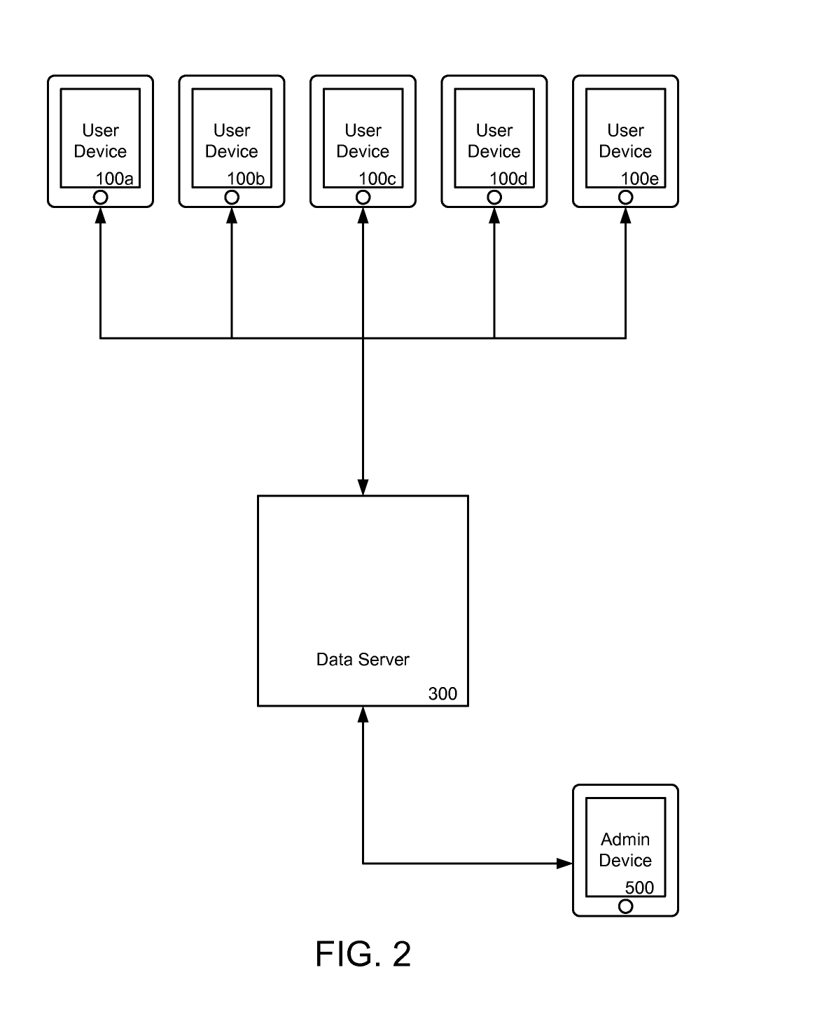

FIG. 2 is block diagram of a system for tracking time and attendance at a meeting according to an exemplary embodiment of the invention. As shown in FIG. 2, the system includes a plurality of user devices 100a-100e, a data server 300, and an admin device 500. The admin device 500 can send meeting preparation materials, meeting time data, meeting location data, and meeting duration data to the data server 300. The plurality of user devices 100a-100e can receive meeting preparation materials, meeting time data, meeting location data, and meeting duration data from the data server 300. The plurality of user devices 100a-100e can each respectively send to the data server 300 preparation time data, comments on meeting preparation material or related material, and attendance data. The admin device 500 can receive aggregated participant data from the data server 300. The aggregated participant data can include, for each of the user devices, preparation time data, comments on meeting preparation material or related material, and attendance data.

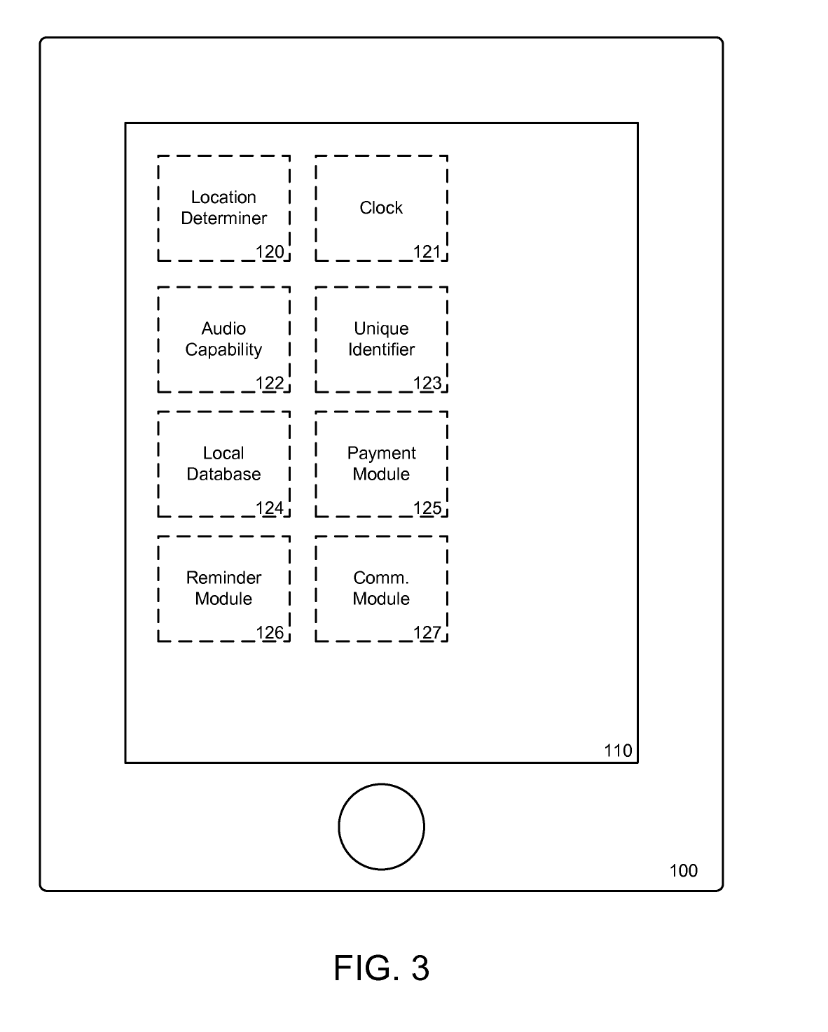

FIG. 3 is a block diagram of a user device according to an exemplary embodiment of the invention. As shown in FIG. 3, the user device 100 includes a screen 110, a location determiner 120, a clock 121, an audio capability 122, a unique identifier 123, and a local database 124, a payment module 125, a reminder module 126, and a communications module 127. The screen 110 can be an LCD or OLED display panel. The screen 110 can include an inductive or capacitive touch screen for receiving input from a meeting participant. The screen 110 can display meeting information such as meeting preparation materials, related materials, meeting times, meeting locations, and meeting duration.

The location determiner 120 can determine the location of the user device. The location determiner 120 can be manifest in many forms. The location determiner 120 can be a GPS module which calculates the location of the user device 100 using GPS satellites (not shown). The location determiner can retrieve a list of nearby wireless access points, relative signal strengths, and the MAC address of each. The location determiner can cross references the list of access points and MAC addresses against a database of known locations for the wireless access points. Together with the relative signal strengths of the wireless access points, the location determiner 120 can approximate a device location. The location determiner 120 can also retrieve a list of nearby cell phone towers and relative signal strengths. The list of towers and signal strengths can be cross referenced against a list of known locations for the towers and a device location can be approximated.

The clock 121 can be an internal clock to the user device 100. The clock 121 can indicate the present time, or preferably a standardized time such as Greenwich Mean Time. The clock 121 can be synchronized with a standardized time as reported by a cell phone network or retrieved from an internet server. The clock 121 can be used to indicate, for example, when the current time is near the meeting time or when the current time is after the meeting duration.

The audio capability 122 can be a speaker coupled to a sound generation device such as a soundcard embedded in the user device 100. The audio capability 122 can be used by the user device 100 to indicate an alarm condition or acknowledge input by the meeting participant. The user device 100 can be a smart phone and the audio capability can be a ringer for the smart phone. In preferred embodiments of the invention, the audio capability 122 is selectively disabled in response to criteria so that inadvertent noises do not disturb the meeting. The audio capability 122 can be selectively disabled in response to input from the meeting participant. The audio capability 122 can be selectively disabled when the location determiner 120 indicates that the user device 100 is near the meeting location. The audio capability 122 can be selectively disabled when the clock 121 indicates the current time is near the meeting time. The audio capability 122 can be selectively enabled in response to input from the meeting participant, when the location determiner 120 indicates the user device 100 is not near the meeting location, or when the clock 121 indicates that meeting duration has elapsed. The meeting location can have a wireless access point known to the user device 100. The audio capability 122 can be disabled when the user device 100 detects the wireless access point and can be enabled when the user device no longer detects the wireless access point.

The unique identifier 123 can identify the user device 100 or the meeting participant to the data server (not shown) or administrator device (not shown). The unique identifier 123 can represent meeting participant. The unique identifier 123 can be a username or participant name. The unique identifier 123 can be the MAC address of a network interface of the user device 100. The unique identifier 123 can be used to associate related data at the data server (not shown) or at the admin device (not shown). In preferred embodiments, the admin device (not shown) can display preparation time data and attendance data displayed for each unique identifier.

The local database 124 can store data such as meeting time, meeting location, meeting duration, preparation materials, and related materials received from the data server 300. Data stored in the local database 124 can be available when the user device 100 is not connected to the data server 300. The local database 124 can store information generated by a meeting participant such as preparation time, attendance data, and comments on the preparation materials or related materials. Information entered into the local database 124 by the meeting participant can be synced to the data server 300 at specified times to conserve battery power or when an network connection is available.

The payment module 125 can facilitate a payment from the meeting participant to a meeting organizer or other party. In the example of a religious service, the payment module can facilitate a donation to the religious organization. In the example of a gym meeting, the payment module can facilitate the payment of a fee to a personal trainer or workout class instructor. The payment module can use third-party payment systems, such as Paypal™ or Google Checkout™. The payment module accept standard credit cards, such as Visa™, American Express™, and Master Card™. The payment module can generate and send a purchase order to the meeting organizer or organization that can subsequently issue an invoice.

The reminder module 126 can activate an indicator on the user device 100 to remind a meeting participant to prepare for the meeting on a periodic basis. The reminder module 126 can also activate an indicator on the user device 100 to remind the meeting participant to attend a meeting. The communications module 127 can facilitate communications between the user device and external services and networked computers. The communications module 127 can send, receive, and synchronize data between the local database 124 and the data server (not shown).

A meeting can include many types of gatherings. For example, a meeting can be a religious service, a business meeting, a gym meeting, a school meeting. A meeting organizer can be a religious official, a speaker at an event, a personal trainer at a gym, and instructor, teacher, or professor at a school or class. Preparation time can represent time praying, independent study, independent workout, or reading. Meeting time can be the time that a meeting starts such as the time of a religious service, the time of an academic class, the time of a business meeting, or the time of a session with a personal trainer. The meeting location can be the location of the religious service, the location of a gym, the location of a school or class, or the location of a business meeting. The meeting duration can be the length of a religious service, the length of a personal training session, the length of a class, or the length of a business meeting.

Meeting preparation materials can be religious texts or portions thereof. Meeting preparation materials can be a workout routine or a diet plan. Meeting preparation materials can be documents relating to the subject matter of the meeting and chosen by the meeting organizer. Meeting preparation materials can be study materials such as chapters from a textbook or scholarly articles. While many types of meetings, materials, locations, and durations have been disclosed, the invention is not constrained to the

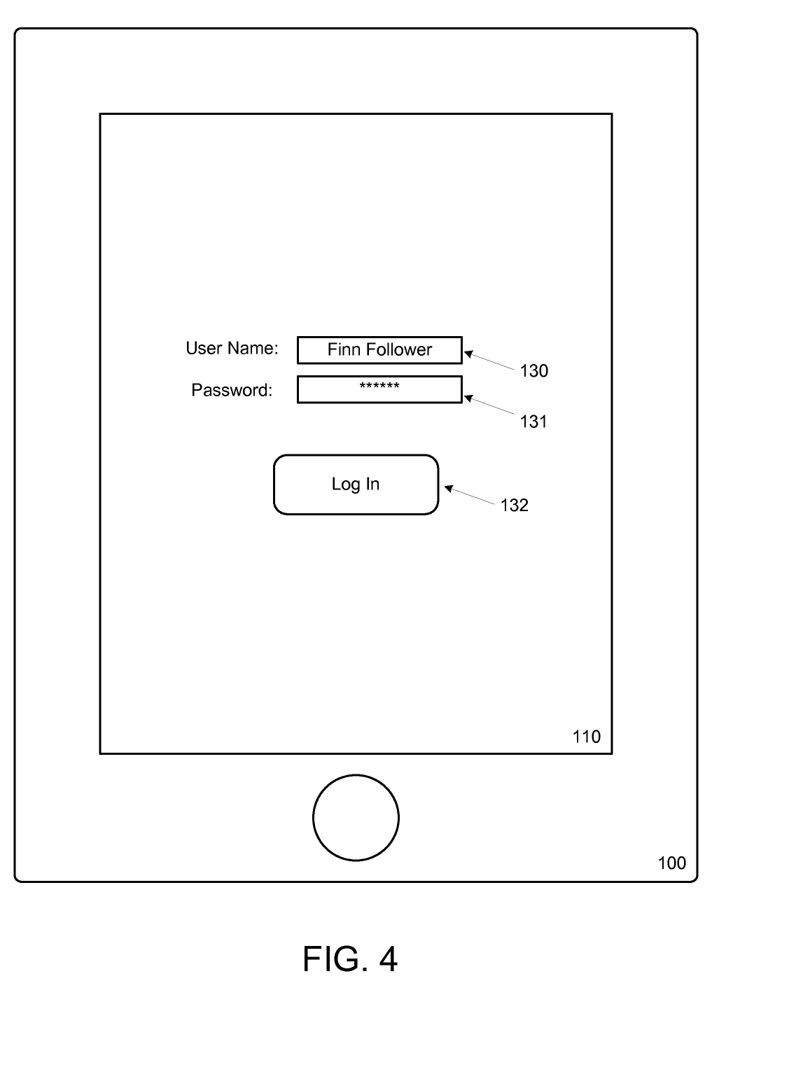

FIG. 4 is drawing of a login feature for a user device according to an exemplary embodiment of the invention. As shown in FIG. 4, the login feature of the user device 100 includes a username field 130, password field 131, and a login button 132. The user name field 130 can receive input from a meeting participant. The username field 130 can receive a unique identifier as described in conjunction with FIG. 3, element 123. The password field 131 can receive a password associated with a username and can be used to authenticate a meeting participant to the user device 100 or the data server (not shown). The login button 132 can initiate the process of authenticating the username and password combination with user device 100 or the data server (not shown).

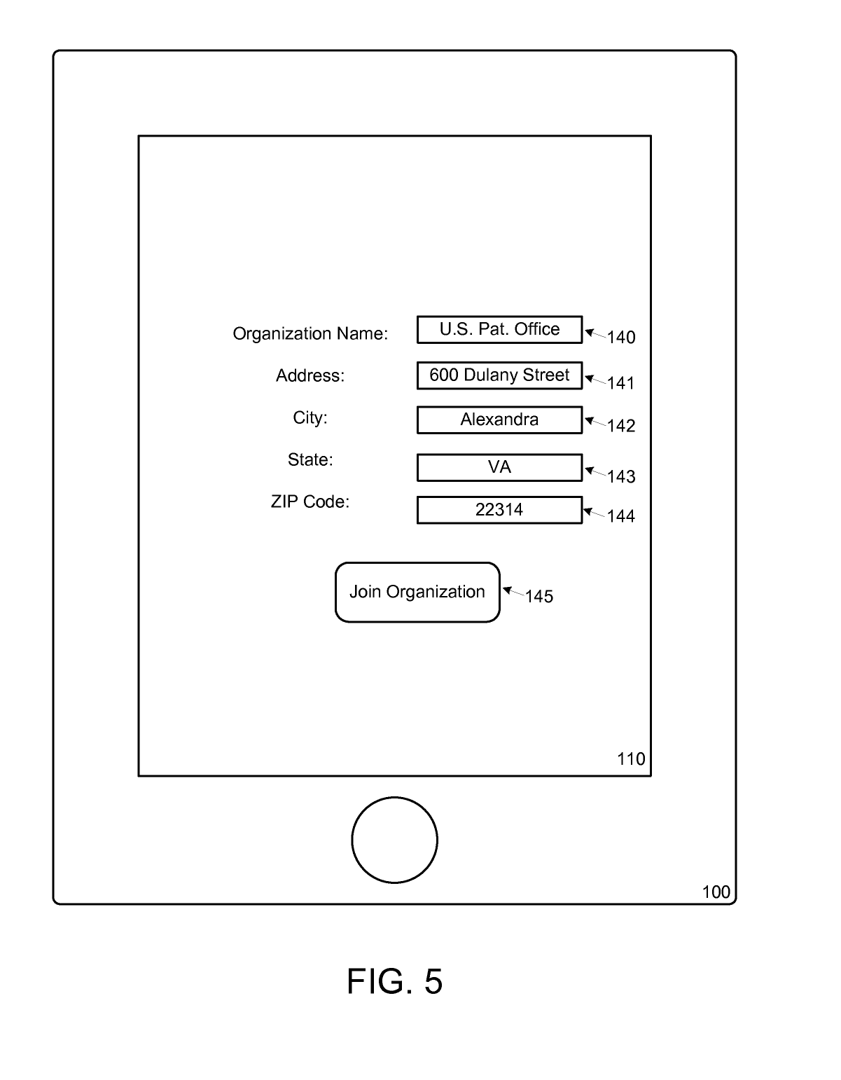

FIG. 5 is a drawing of a organization selection feature for user device according to an exemplary embodiment of the invention. As shown in FIG. 5, the organization selection feature of the user device 100 includes an organization name 140, address 141, city 142, state 143, ZIP code 144, and a join organization button 145. The organization selection feature can allow a meeting participant to associate with an organization that conducts meetings, receive meeting information relating to that organization, and report preparation time and attendance data back to the organization. The organization selection feature can receive input from the meeting participant such as organization name 140, address 141, city 142, state 143, and ZIP 144. The join organization button 145 can send the entered data to the data server (not shown) for the purposes of identifying and associating with the organization.

While organization selection feature has been illustrated as the identification of address data, other implementations of the organization selection feature are contemplated. For example, the user device 100 can receive a list of organizations from the data server. The list of organizations can be limited those organizations within a predetermined radius of the user device 100, or within a predetermined radius of a location selected by the meeting participant. Organizations can further be identified by a unique identifier such as an unique number and the organization selection feature can include input to receive that unique number.

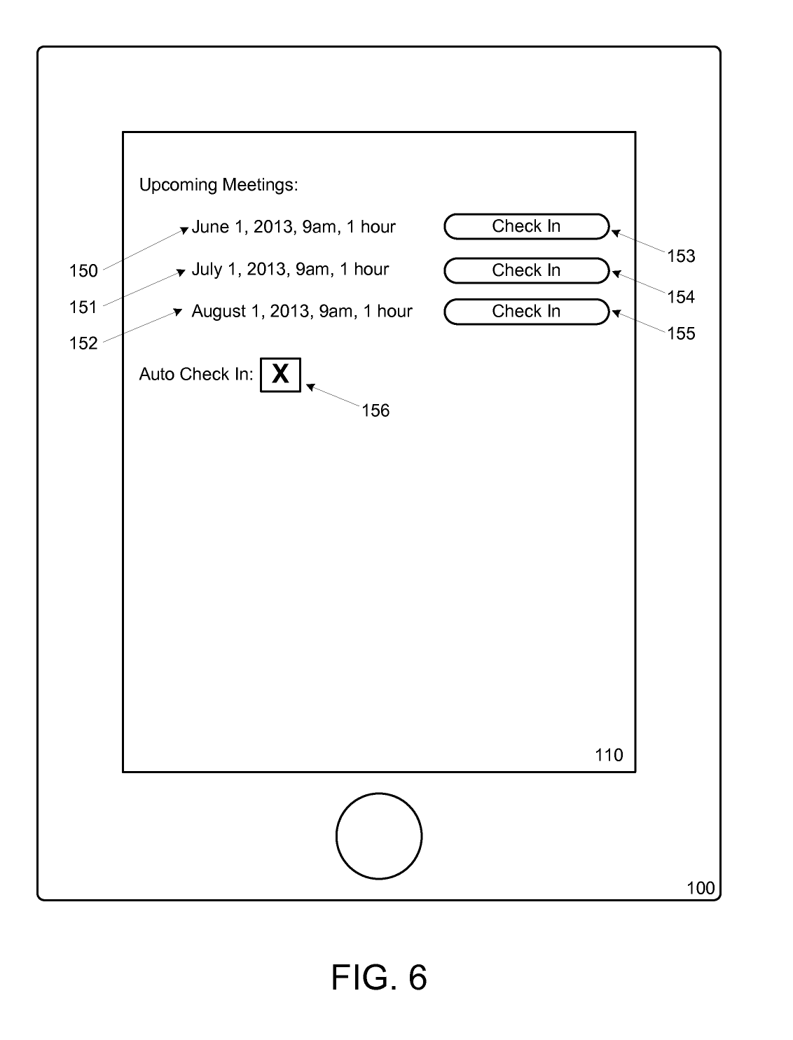

FIG. 6 is a drawing of a meeting display feature for a user device according to an exemplary embodiment of the invention. As shown in FIG. 6, the meeting display feature can display meetings 150, 151, and 152 on the screen of the user device 100. The meetings can be displayed in chronological order such that the nearest meeting is displayed first. The display of the meetings 150, 151, and 152 can include the date, time, and duration for the meetings 150, 151, and 152.

The meeting display feature can further include a check in button 153, 154, and 155 for each of the meetings 150, 151, and 152, respectively. A meeting participant can indicate attendance at a meeting by selecting one of the check in buttons 153, 154, and 155. The attendance data can be stored in a local database and periodically synchronized with the data server. The attendance data can be immediately synchronized with the data server.

The meeting display feature can also include an auto check in feature 156. In preferred embodiments of the invention, attendance at a meeting by a meeting participant can be automatically recorded in the local database and synced to the data server when the time is near meeting time and/or the location of the user device 100 is near the meeting location.

Each of the meetings 150, 151, and 152 can be selectable for example by a mouse click or a touch input from the meeting participant. When a meeting 150, 151, and 152 is selected, the user device 100 can display additional information for the meeting such as meeting preparation materials or related materials.

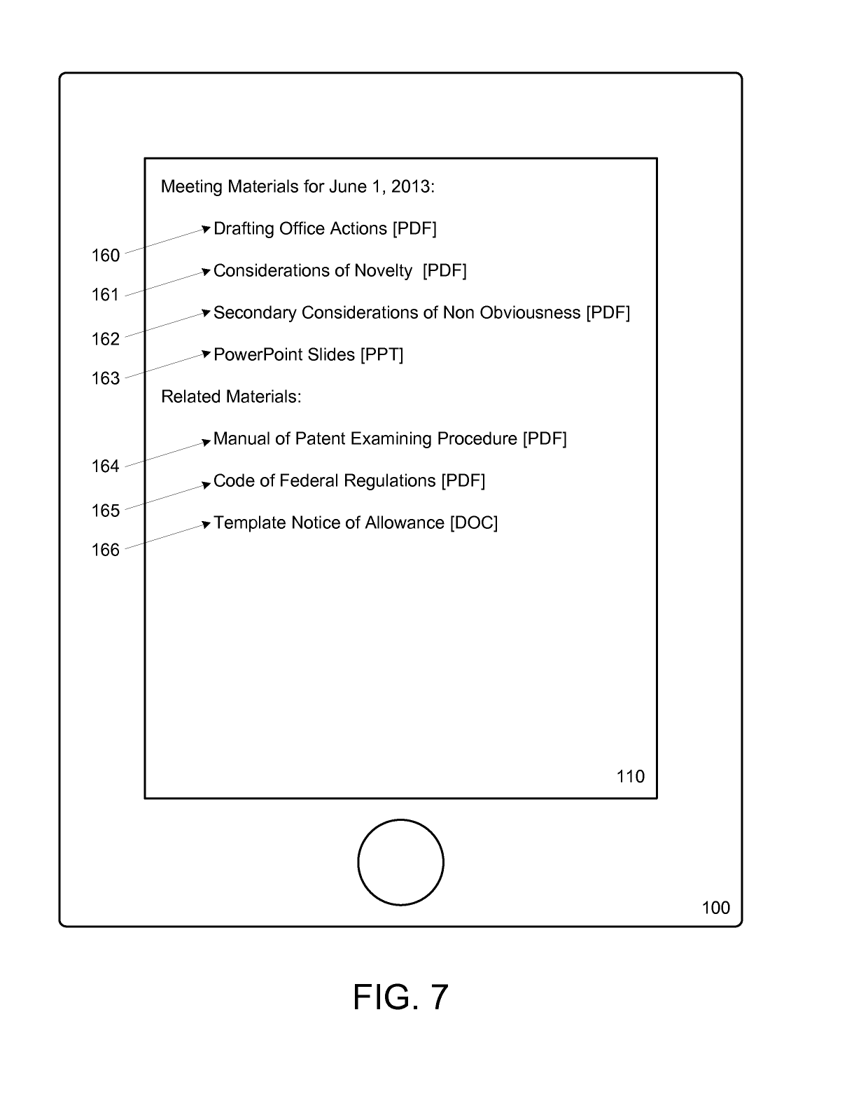

FIG. 7 is a drawing of a meeting materials feature for a user device according to an exemplary embodiment of the invention. As shown in FIG. 7, the meeting materials feature of the user device 100 includes a list of selectable meeting preparation materials 160-163 and a list of selectable related materials 164-166. The meeting preparation materials 160-163 can be materials selected by a meeting organizer to be discussed at a meeting. For example, in a continuing education meeting for patent examiners, the meeting preparation materials can be a tutorial on drafting office actions 160, a document describing considerations of novelty 161, a reading on the secondary considerations of non-obviousness 162, and the power point slides for the meeting 163. When selected, the meeting preparation materials 160-163 can be displayed on the user device.

Related materials 164-166 can include materials which are related to the subject matter of the meeting but are not necessarily selected by the meeting organizer. Related materials can be considered further reading related to the subject matter of the meeting. In the above example of a continuing education meeting for patent examiners, related materials can include a copy of the Manual of Patent Examining Procedure 164, the Code of Federal Regulations 165, and a template notice of allowance 166.

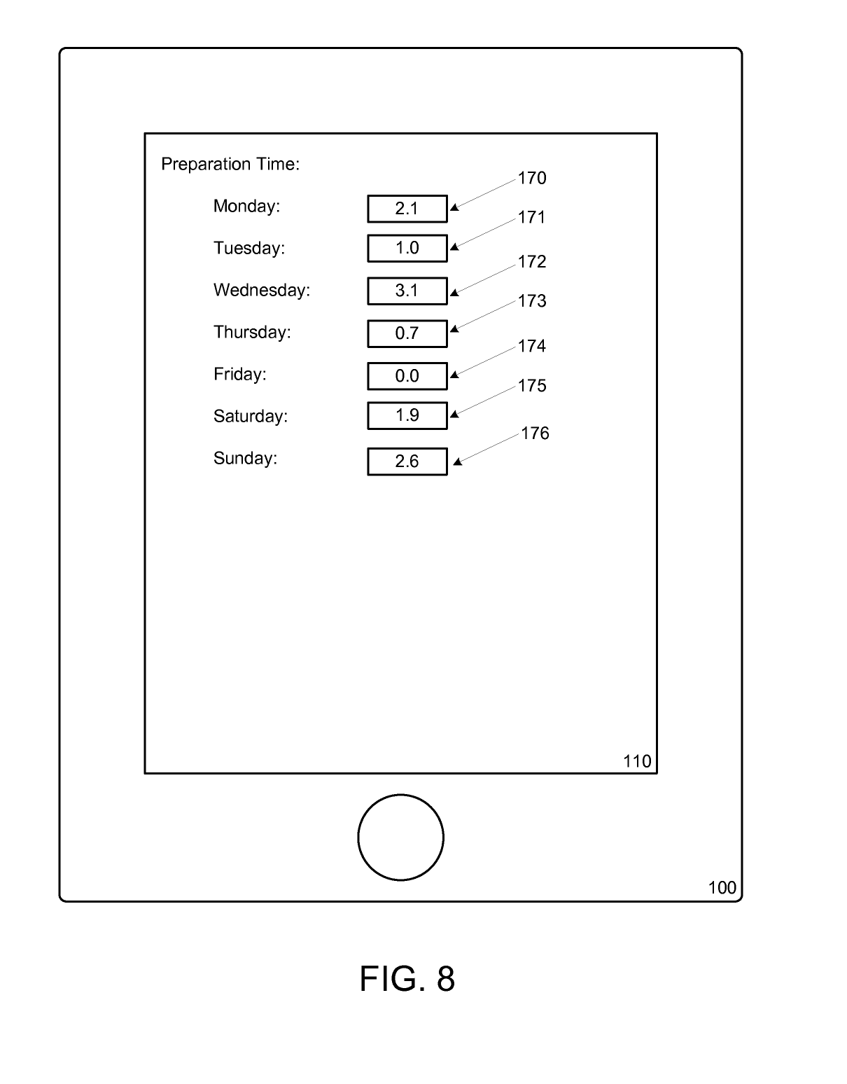

FIG. 8 is a drawing of a preparation time entry feature for a user device according to an exemplary embodiment of the invention. As shown in FIG. 8, the preparation time entry feature includes preparation time input fields 170-176 for each day of the week. In use, a meeting participant can record the time spent preparing for the meeting each day. In another embodiment of the invention, the time entry feature can include a calendar display having selectable days wherein a meeting participant can record time spent on a daily basis. The preparation time data can be stored in a local database (not shown) and synced to the data server (not shown).

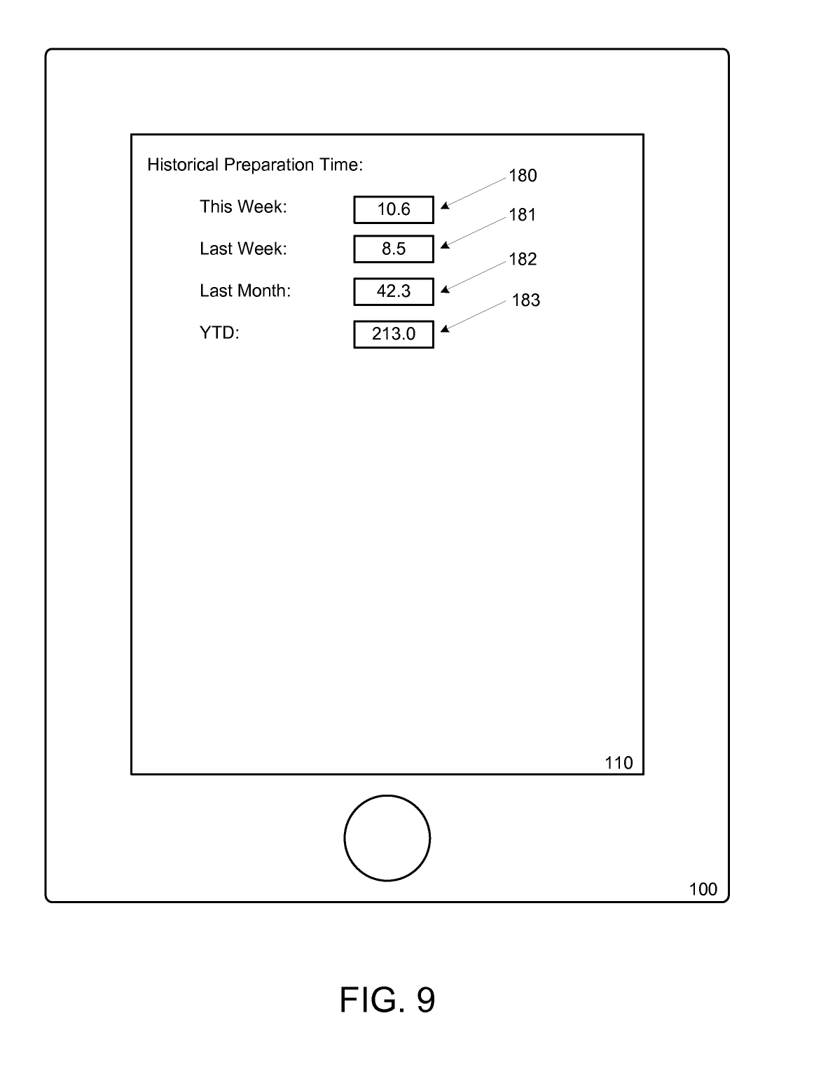

FIG. 9 is a drawing of a historical preparation time display feature for a user device according to an exemplary embodiment of the invention. As shown in FIG. 9, the historical preparation time feature of the user device 100 can include cumulative preparation times 180-183 for various predetermined or user selectable time periods. The historical preparation time feature can also include historical meeting attendance data (not shown) reporting meetings attended on a weekly, monthly, or yearly basis.

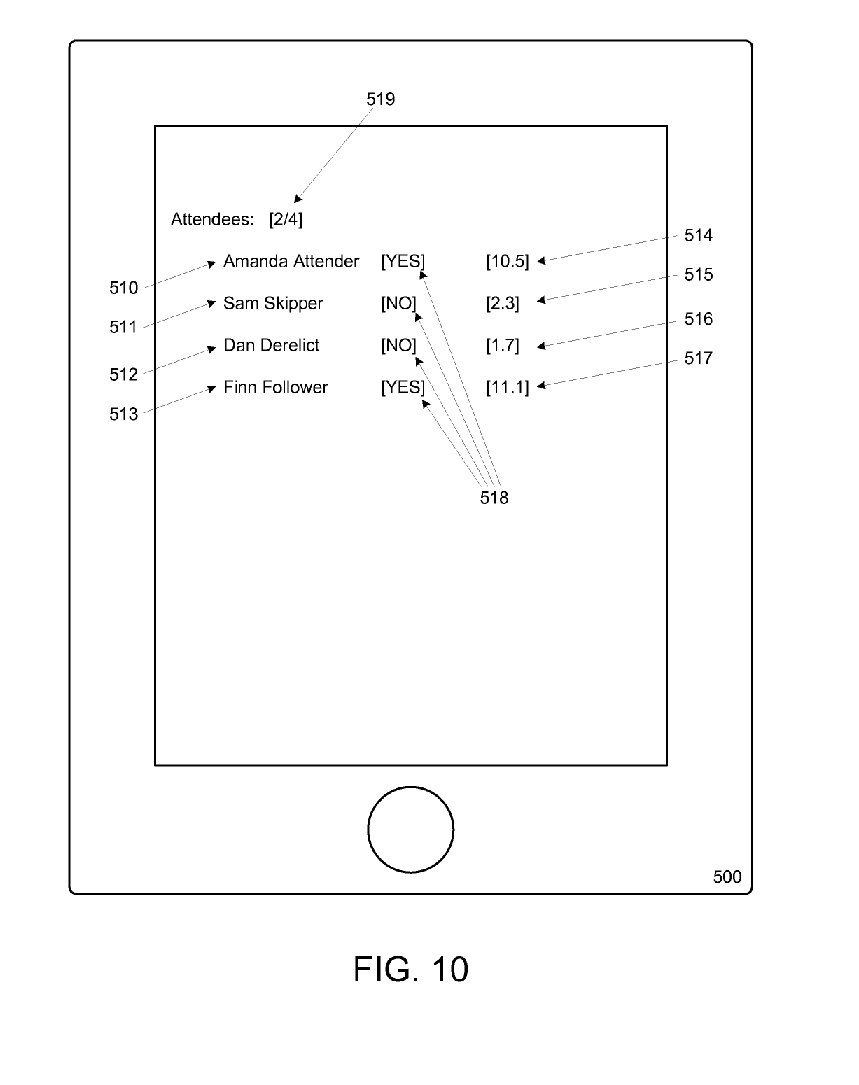

FIG. 10 is a drawing of a meeting attendance and preparation time display feature for an administrator device according to an exemplary embodiment of the invention. As shown in FIG. 10, the meeting attendance and preparation time display feature for an administrator device 500 includes a list of meeting participants 310-313, an attendance status 318 for each of the meeting participants 310-313, a meeting preparation time 314-317 for each of the meeting participants 310-313, and an attendance quotient 319. The list of meeting participants 310-313 can include the meeting participants who have joined the organization as described in conjunction with FIG. 5, above. The attendance status 318 for each of the meeting participants 310-313 can indicate whether each of the meeting participants 310-313 has indicated their presence at the meeting.

The meeting preparation time 314-317 for each of the meeting participants 310-313 can indicate the cumulative time spend preparing for the meeting. The meeting preparation time 314-317 can be cumulated over a time period such as a week or a month the time since the previous meeting of the organization. Each of the participants 310-313 can be individually selectable and the administrator device 500 can display detailed information on the selected participant. Detailed information on the participants 310-313 can include daily preparation time for each participant as described in conjunction with FIG. 8 or historical preparation time for each participant as described in conjunction with FIG. 9. Detailed information on the participants 310-313 can include historical attendance data for each participant.

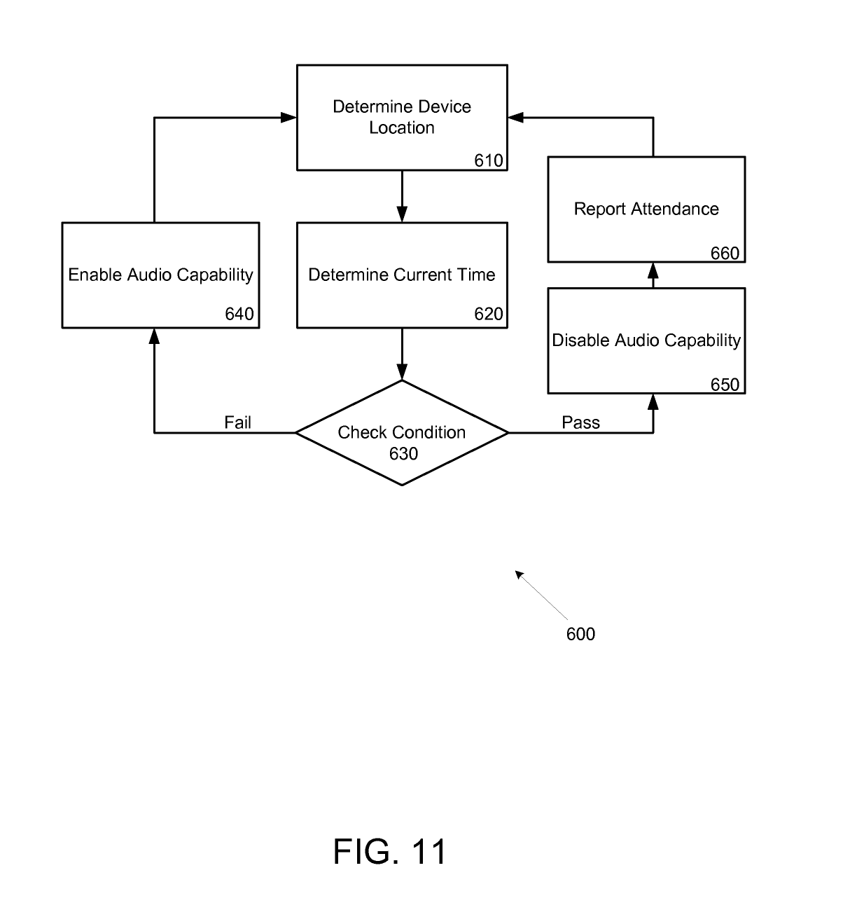

FIG. 11 is a process flow chart for a selectable audio capability according to according to an exemplary embodiment of the invention. As shown in FIG. 11, the selectable audio capability can be enabled 640 or disabled 650 in response to a condition 630. The process 600 includes determining the location 610 of the user device and determining the current time 620. The condition check step 630 can be responsive to conditions such as the device location determined in step 610 or the current time determined in step 620. For example, the condition check step 630 can PASS if the current time is near the meeting time. The condition check step 630 can PASS if the device location is near the meeting location. The condition check step 630 can PASS if both the device location and current time are near the meeting location and meeting time, respectively.

If the condition check step 630 reports PASS, the user device can disable the audio capability 650 so as not to disturb other meeting participants with unintended sounds emitted from the user device. If the condition check step 630 reports a PASS, the user device can report attendance 660 to the local database on the user device and/or the data server. The selectable audio capability process can further include enabling the audio capability 640 when the condition check step 630 indicates FAIL, for example, when the current time is after the meeting duration or when the user device is not near the meeting location.

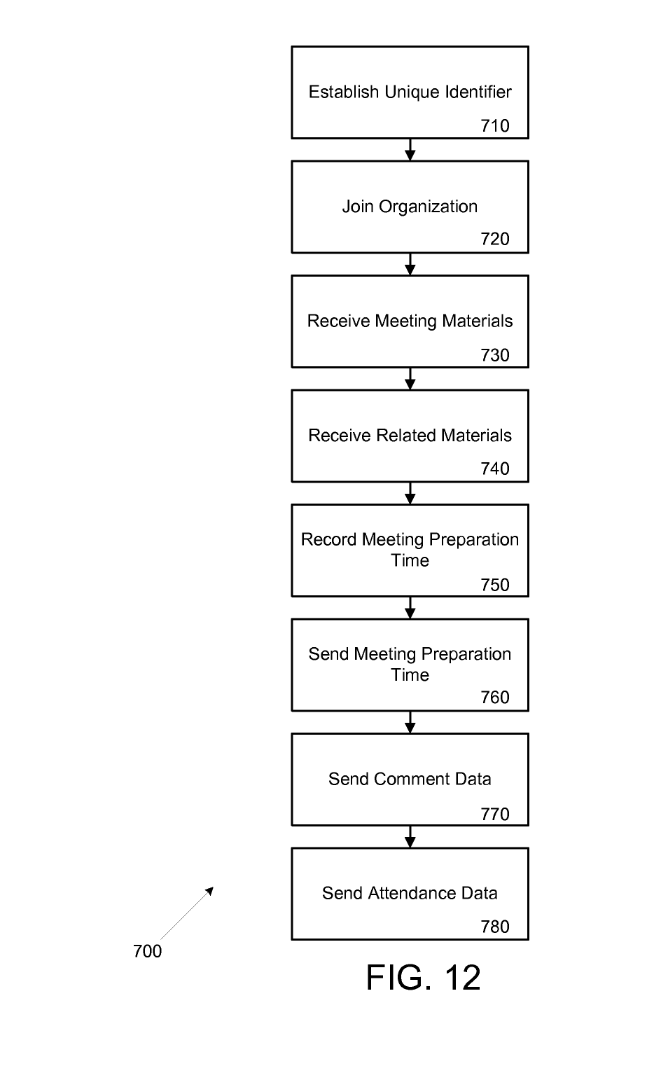

FIG. 12 is a process flow chart for recording time and attendance data at a user device according to an exemplary embodiment of the invention. As shown in FIG. 12, the process 700 for recording time and attendance data at a user device includes establishing 710 a unique identifier. The unique identifier can be a username associated with the meeting participant. The unique identifier can be chosen by the meeting participant or assigned by the data server (not shown). The process 700 can further include joining 720 an organization, such as a church, a gym, or a school. The unique identifier associated with the meeting participant can be transmitted to the data server (not shown) to indicate the meeting participant's intention to attend meetings for the organization.

The process 700 can further include receiving meeting preparation materials 730 relating to meetings of the organization such as notes, slides, research, or study materials. The process 700 can further include receiving related materials 740 which relate generally to the subject matter of a meetings, but are not necessarily required for preparation for any particular meeting. The process 700 can further include recording 750 preparation time for meetings. Preparation time can include time spent reviewing meeting preparation materials or related materials or performing activities or practice specified in the preparation materials. Preparation time can be stored in a local database in local memory on the user device in RAM, cache, or flash memory.

The process 700 can further include sending meeting preparation time 760 to the data server (not shown). The process 700 can further include sending comment data 770 to the data server (not shown). Comment data can include a meeting participant's thoughts or impressions on the meeting preparation materials or related materials. Comment data from other meeting participants can also be received on the user device. The process 700 further includes sending attendance data to the data server (not shown). Attendance data can indicate, for example, that the meeting participant attended or did not attend a particular meeting of the organization.

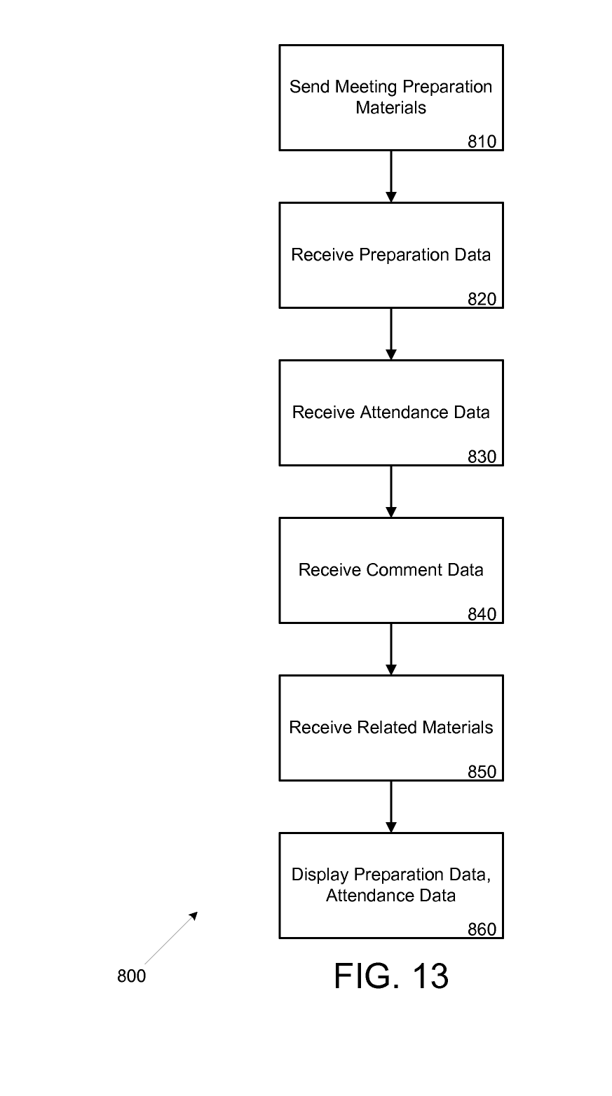

FIG. 13 is a process flow chart for reviewing time and attendance data at an administrator device according to an exemplary embodiment of the invention. As shown in FIG. 13, the process 800 includes sending meeting preparation materials 810, receiving preparation time data 820, receiving attendance data 830, receiving comment data 840, receiving related materials 850, and displaying preparation time and attendance data 860.

Sending meeting preparation materials 810 can include a meeting organizer selecting certain materials that are relevant to a meeting such as Power Point slides or readings and uploading those materials using the administrator device to the data server. Meeting preparation materials on the data server can be retrieved by user devices owned or controlled by meeting participants for independent study.

Receiving preparation data 820 can include receiving preparation data pertaining to each meeting participant. The preparation data can be received from the data server. The preparation data for each participant can be sent to the data server by each participant. The received preparation data can include time spent preparing for the meeting on a daily, weekly, monthly, or hourly basis.

Receiving attendance data 830 can include receiving, at an admin device, attendance data for each meeting participant. More specifically, receiving attendance data 830 can include receiving data indicating whether each participant was present at a particular meeting. Receiving attendance data 830 can further include the time each participant arrived at the meeting. Arrival times can indicate whether a participant was early, on time, or late to the meeting and could further indicate if certain portions of key information disseminated at the meeting was missed by a particular participant.

Receiving comment data 840 can include receiving, at an admin device, comment data from participants on each of the meeting preparation materials or related materials. Comment data can be specific to a particular preparation material or a particular related material. Comment data can be provided by one or more meeting participants. Comment data can relate generally to the subject matter of the meeting. In preferred embodiments, comment data is correlated to a particular meeting participant so a meeting organizer can determine which participant has made certain comments. Comment data can be used by a meeting organizer to tailor the administration of the meeting to focus on issues raised by user comments. In the context of an academic class, a comment by a student can be “this was easy” or “this was hard” which could indicate to the meeting organizer, e.g. a teacher, that more or less time should be dedicated to particular material in the class meeting. In preferred embodiments, the meeting organizer can review comments in advance of the meeting and provide comments by the meeting organizer which can be received by each of the meeting participants.

Receiving related materials 850 can include receiving, at an admin device, materials related to the subject matter of the meeting. The related materials can be selected by the data server by key words or subject matter of the meeting. The related materials can be selected by an administrator of the data server. In the context of a religious meeting, meeting preparation materials may be a specific reading in a holy book while the related materials may be other passages from the same holy book or articles discussing the holy book.

Displaying preparation data and attendance data 860 can include displaying, on the admin device, aggregated data for each meeting participant. The aggregated data can indicate, for each participant, the amount of preparation time and whether the participant is in attendance. The displaying 860 can further include a detailed display for each participant including preparation time on a daily basis or cumulatively over a week, month, or year. The displaying 860 can further include historical preparation and attendance data for each participant. The displaying 860 can include cumulative data for all participants such as cumulative preparation time and cumulative attendance data.

It will be apparent to those skilled in the art that various modifications and variations can be made in the system for tracking preparation time and attendance at a meeting of embodiments of the invention without departing from the spirit or scope of the invention. Thus, it is intended that embodiments of the invention cover the modifications and variations of this invention provided they come within the scope of the appended claims and their equivalents.

What is claimed is:

1. A device for tracking preparation time and attendance at a meeting to occur at a meeting time and a meeting location for a meeting duration, the device comprising:
a location determiner configured to determine a device location for the device;
a clock configured to determine a current time;
an audio capability, the audio capability configured to be disabled in response to at least one of a location event and a time event;
a unique identifier which is transmitted from the device indicating attendance at the meeting;
a database configured to store a preparation time, the meeting time, meeting location, and meeting duration, and a meeting preparation materials; and
a screen configured to display the preparation time, the meeting time, meeting location, and meeting duration, and the meeting preparation materials.

2. The device of claim 1, wherein the audio capability is disabled for when the time event is the meeting duration;

3. The device of claim 1, wherein the audio capability is disabled when the location event is the device location is near the meeting location;

4. The device of claim 1, further comprising a commenting module configured to receive a text comments regarding the meeting preparation materials.

5. The device of claim 1, further comprising a payment module configured to transfer a funds relating to the meeting.

6. The device of claim 1, further comprising a reminder module configured to indicate to a user to prepare for the meeting.

7. The device of claim 1, further comprising a communications module configured to send the preparation time and an attendance data and configured to receive the meeting preparation materials.

8. The device of claim 1, wherein the unique identifier is transmitted when the device location is near of the meeting location.

9. The device of claim 1 wherein the meeting is a religious service; the preparation time is prayer time; the meeting time is a time of the religious service; the meeting location is a location of the religious service; the meeting duration is a duration of the religious service; and the meeting preparation materials are a religious text.

10. The device of claim 1 wherein the meeting is an appointment with an athletic trainer; the preparation time is an independent workout time; the meeting time is a time of the appointment; the meeting location is the location of the appointment; the meeting duration is a length of the appointment; and the meeting preparation materials are a workout routine.

11. The device of claim 1 wherein the meeting is a class; the preparation time a study time; the meeting time is a time of the class; the meeting location is a location of the class; the meeting duration is a length of the class; and the meeting preparation materials are a study materials;

12. A system for tracking preparation time and attendance for a plurality of attendees at a meeting to occur at a meeting time and a meeting location for a meeting duration, the system comprising:
a user device, the user device includes:
a location determiner configured to determine a device location;
a clock configured to determine a current time;
an audio capability, the audio capability being selectively disabled in response to a criteria;
a unique identifier;
a communications module configured to receive the meeting time, meeting location, meeting duration, a meeting preparation materials, and a related materials; and configured to send a preparation time data and an attendance data;
a first database configured to store the meeting time, the meeting location, the meeting duration, the meeting preparation materials, the related materials, the preparation time data, and the attendance data;
a screen configured to display the preparation time data, the meeting time, the meeting location, the meeting duration, and the meeting preparation materials;
a data server, the data server includes:
a communications module configured to receive a preparation time, an attendance data, and a unique identifier for each of the plurality of attendees and configured to send the meeting time and duration to each of the plurality of attendees;
a second database configured to store a meeting time, a meeting location, and a meeting duration; and configured to store the preparation time data, the attendance data, and unique identifier for each of the plurality of attendees;
a third database configured to store a plurality of related materials pertaining to a subject matter of the meeting;
an administrator device, the administrator device includes:
a communications module, the communications module includes:
a receiver configured to receive a preparation time, an attendance data, and a unique identifier for each of the plurality of attendees; and
a transmitter configured to send a meeting preparation materials; and
an analytics module.

13. The system of claim 12 wherein the criteria is when the device location is near the meeting location.

14. The system of claim 12 wherein the criteria is when the current time is near the meeting time.

15. The system of claim 12 wherein the analytics module includes a processor configured to determine a collective attendance rate for the plurality of attendees at the meeting.

16. The system of claim 12 wherein the analytics module includes a processor configured to determine a historical attendance rate for each of the plurality of attendees, respectively.

17. The system of claim 12 wherein the analytics module includes a processor configured to determine a collective preparation time for the plurality of attendees at the meeting.

18. The system of claim 12 wherein the analytics module includes a the processor configured to determine a historical preparation time for each of the plurality of attendees, respectively.

19. A method for tracking preparation time and attendance at a meeting on a user device, the meeting to occur at a meeting time and a meeting location for a meeting duration, the method comprising:
receiving the meeting time, meeting location, meeting duration, and a meeting preparation material;
recording a meeting preparation data;
sending the meeting preparation data and a unique identifier to a data server;
determining a location of the user device;
determining a current time;
reporting an attendance data and the unique identifier to the data server;
disabling an audio capability of the user device;

20. The method of claim 19 wherein the reporting occurs when the current time is near the meeting time and when the user device is near the meeting location.

21. The method of claim 19 wherein the disabling occurs when the current time is near the meeting time and when the user device is near the meeting location;

22. The method of claim 19 further comprising enabling the audio capability after the meeting duration.

23. The method of claim 19 further comprising receiving a comment data relating to the meeting preparation material.

24. The method of claim 19 further comprising sending a comment data relating to the meeting preparation material.

25. The method of claim 19 wherein the unique identifier is a username.
